(19) United States
(12) Patent Application Publication
(10) Pub. No.: US 2002/0163680 A1
(43) Pub. Date: Nov. 7, 2002

(54) Methods and apparatus for producing simultaneous and near real time holographic imagery

(76) Inventor: J. Britton Zabka, Albuquerque, NM (US)

Correspondence Address: RODEY, DICKASON, SLOAN, AKIN & ROBB, PA, P.O. BOX 1888, ALBUQUERQUE, NM, 87103, US

(21) Appl. No.: 10/186,584

(22) Filed: Jul. 1, 2002

Related U.S. Application Data
(62) Division of application No. 09/823,408, filed on Mar. 30, 2001.

(51) Int. Cl. G03H 1/00; G03H 1/10

(52) U.S. Cl. 359/10; 359/1

(57) ABSTRACT

Holographic printers for producing simultaneous and near real time white light viewable holographic imagery are disclosed. Such printers include fiber optics for dividing the reference beam into a plurality of identical reference beams each intersecting the object beam path at the recording medium. In one embodiment, the recording medium is simultaneously exposed to both the object beam and the plurality of reference beams. An alternate embodiment is provided for sequentially opening each of the reference beam shutters with the opening of the object beam shutter. Preferably, the printer includes a liquid crystal panel and a computer for supplying images in the liquid crystal panel between each sequential opening of the shutters. For the formation of integral holograms, fiber optics are provided for dividing the object beam. The printers disclosed herein avoid the mechanical repositioning (of the film plane, or either one of the recording beams), stop, wait, expose and repeat process of prior art composite and integral holographic printers.

### FIELD OF THE INVENTION

These inventions relate to high speed holographic printers. More specifically, this relates to unique printers which produce high diffraction efficiency, white light viewable holograms from either simultaneous or near real time multiple sequential exposures. The printers disclosed herein avoid the mechanical repositioning (of the film plane, or either one of the recording beams), stop, wait, expose and repeat process of prior art composite and integral holographic printers.

### BACKGROUND OF THE INVENTION

A hologram is produced by recording in the film plane of the recording medium the overlapping stationary interference patterns of two wavefronts of mutually coherent light. The coherent light is derived from a coherent laser, separated by a beam splitter. The beams must be mutually coherent, remain in phase, and have the same frequency and polarization during exposure. Any change in the phase of the two beams, or the fringes, or polarization and will have a significantly adverse effect on the formation of the interference pattern and affect the diffraction efficiency of the finished hologram.

Composite and integral holographic printers can record a multiplicity of holograms on a single recording medium which, typically, can be viewed in ambient light. The holograms can be arranged in a plane with each hologram printed linearly (i.e., an integral) with respect to each preceding exposure, or overlapped in a layered fashion (i.e., composite) enabling one to observe a range of perspectives when viewing the final hologram. In integral holograms, both the reference beam and object beam information are typically brought to a near focus slit at film plane. With numerous holograms printed side by side to increase viewing parameters, the reconstructed hologram generally appears at a distance from the film plane. Composite holograms generally focus object information directly onto a film plane with overlapping reference beams, producing a reconstructed hologram that typically straddles the film plane of the recording medium (image plane). Fewer images can be tolerated to produce a full field of view.

In such known printers for recording multiple holograms, the recording typically involves the use of various optical components, and the mechanical translating of the recording medium in increments, in a step (e.g. incremental movement of the film), stop, wait, expose and repeat process. Typically, after an image is exposed on the recording medium, the recording medium is moved a predetermined amount, the holographic printer is then dormant for a period of time sufficient for the system to settle, and then process is repeated until completion. In forming such a hologram, the system that records the interference wavefronts must be stationary during each exposure, because the recording medium acts like membrane that resonates with any slight vibration, including vibrations of the printer. If such vibrations are greater than the amplitude of a fraction of a wavelength they will cancel the recording of the interference pattern and severely degrade or cancel the finished hologram recording.

Heretofore, there are no known methods of producing on, for instance, polymer film white light viewable holograms having high diffraction efficiency from multiple beam exposures. Mechanical repositioning, of either the object beam or the recording medium of prior art holographic printers, makes it physically impossible for these systems to eliminate the settling time required between each successive exposure. The basic image plane composite techniques either mechanically reposition the recording beams in a back and forth fashion, as in U.S. Pat. No. 5,796,500 to S. J. Hart, or use a galvanometer driven mirror that moves the position of the angle of incidence of the recording beams, as set forth in U.S. Pat. No. 5,098,126 to W. E. Wolf. U.S. Pat. No. 5,046,792 to J. B. Zabka describes a printer and production technique in which the object information rotates in unison with the film plane, but with a stationary reference beam. The integral holographic printer disclosed in U.S. Pat. No. 5,223,955 to J. B. Zabka also incorporates a translating film holder that can produce high diffraction efficiency holograms with polymer films.

None of the foregoing references teach either near real time multiple exposure techniques or simultaneous multiple exposure techniques. Thus, for instance, while good image plane images are produced by the system of U.S. Pat. No. 5,046,792, its use for industrial applications is limited due to its step, stop, wait, expose and repeat nature. Time losses due to settling time from one exposure to the next are labor intensive and, thus, expensive. Furthermore, these recording techniques are unsuitable for many applications. Commercial, high volume identification card manufacturing cannot tolerate minutes let alone hours for the mass production of individual portraits of customers. In the case of medical applications, medical personnel often need to view internal patient images immediately for life saving decisions. Even when time is not critical, the time and cost to produce prior art holographic images has dampened the interest of the industry to utilize composite holography.

Traditional step, stop, wait, expose and repeat holographic methods must allow time for system resonance to dampen after each mechanical repositioning because the recording medium behaves as a membrane. In addition to the vibrations inherent in repositioning, the slow recording nature inherent in the lagtime of prior art printers allows ambient vibrations (e.g., air movement and temperature changes typically present in laboratory environments) to be more prone to adversely effect hologram recording. If the vibration amplitude is greater than a fraction of a wavelength, it will degrade if not cancel the image. The mechanical repositioning required of either one or both of the recording beams and/or recording medium of prior art printers makes it physically impossible to eliminate settling times in between exposures. Thus, much time is lost in allowing system to dampen after each repositioning procedure in between exposures.

Photopolymer film is a homogenous non-scattering material that does not increase noise and produces very high diffraction efficiency. Upon a initial exposure the photopolymer system causes the monomer to polymerize in the film. See, for instance, U.S. Pat. No. 4,950,567. In general, during the first exposure the hologram formation begins rapidly, because the polymerization starts to proceed in regions exposed to light. The hologram is forming in near real time (e.g., seconds). Thus, it is not practical and is often impossible for prior art printers to expose, reposition, and wait to settle, to record multiple holograms on the same film area of photopolymer film before polymerization is completed.

There is an ever increasing number of applications where multiple holograms on a single recording medium are desired, including personal identification, product security, and medical imaging applications. In addition, these applications demand high quality imagery (e.g., exhibiting wide viewing angles and high diffraction efficiency characteristics) that can be produced in a rapid and cost-effective manner. Accordingly, there is a need for printers that produce images simultaneously or in near real time. Requirements demanded by the rapid diffusion mechanism of instant polymer films. Additionally, an ever increasing number of applications desire to employ the increased depth perception and time varying imagery holographic composites and integrals can offer.

To achieve the foregoing, there is a need for holographic printers that do not have any mechanical positioning apparatus which incurs settling times between exposures. In addition it is desirable to have multi-image composite and integral holographic printers that can effectively use a variety of film products, such as photopolymer, photo-resist and dichromate gelatin to further increase the quality of diffraction efficiency and achieve the overall quality these films offer. While a number of holographic systems have been developed, as described above, none offer the feature of rapid multiple exposure recording channels for white light viewable composite and integral hologram production that eliminates the step, stop, wait, expose and repeat process, or that exhibits the essential coherence of object and reference beam with uniform frequency and polarized beams for optimum diffraction efficiency from multiple hologram recordings. This is particularly true for photopolymer film. There has remained an important problem in respect to maintaining a constant phase between the object and reference beam in making holograms so that the fringe pattern of the recording medium remains stationary throughout the multiple recording procedure.

### OBJECTS OF THE INVENTION

It is one of the objects of the present inventions to provide a printer and method for making simultaneous multiple reference beam exposures with a single object beam exposure on film capable of multiple channel recording, to produce a hologram with a wide field of view.

It is another object of the present inventions to provide a technique and system for synthesizing composite holograms while eliminating moving mechanical mechanisms and the associated settling times between exposures.

It is still another object of the present inventions to create holograms with printers utilizing a plurality of different reference beams.

It is a further object of the present inventions to create a plurality of reference beams with fiber optics, the output ends of which are positioned off-axis to the holographic recording medium.

It is a further object of the present inventions to simultaneously expose the recording film with the object beam and, via fiber optics, a plurality of identical reference beams.

It is a further object of the present inventions to produce composite holograms with the use of a plurality of fiber optic based reference beams that are illuminated simultaneously.

It is a further object of the present inventions to produce composite holograms with the use of a plurality of fiber optic based reference beams that are illuminated sequentially.

It is further the object of the present inventions to provide a system that utilizes a plurality of fiber optics, the output ends of which each have multiple positioning capabilities for easy alignment and polarization of the reference beams with equal coherence and frequency.

It is a further object of the present inventions to provide, in conjunction with a printer which utilizes a plurality of fiber optics originated reference beams, lenses for increasing (or decreasing) the diameter of the reference beams and object beam with equal divergence (or convergence) to produce larger (or smaller) holograms.

It is further the object of the present inventions to provide a printer that utilizes a plurality of fiber optics originated reference beams in conjunction with a like plurality of beam modulating lenses, such as cylindrical lenses (to produce a integral hologram).

It is a further object of the present inventions to provide a printer which incorporates a plurality of object beams.

It is further an object of the present inventions to produce high diffraction efficiency, high fidelity images from both composite holograms and linear integral holograms in all types of recording mediums.

It is yet another object of the present inventions to record near real color composite and integral holograms by simultaneously exposing the film with laser light of appropriately selected, different frequencies.

It is further an object of the present inventions to provide for near continuous printing capabilities for efficient, mass-production use.

It is further an object of the present inventions to utilize rapid, near real time exposures from digital camera sequential imaging, via an LCD imager, so as to produce multiple exposure recordings.

It is further an object of the present inventions to utilize a multiple elliptical holographic optical diffuser in front of images, to lessen the vertical color gradient inherent in transmission rainbow holograms, and to increase the angular spread of the x and y dynamic range for increased viewing of the finished hologram.

It is yet another object of the present inventions to produce both reflection and transmission composite image plane holograms and integral holograms.

It is a further object of the present inventions to provide solid state holographic printers.

It is yet a further object of the present inventions to provide holographic printers which incorporate non-mechanical, solid state shutters.

It is an additional object of the present inventions to minimize the need for the heavy isolation systems required by prior art printers, thus providing for more compact, transportable printers.

It is yet a further object of the present invention to reduce the size, weight and cost of holographic printers.

These and other objects will be apparent from the description which follows.

### SUMMARY OF THE INVENTION

A holographic printer including: a source of coherent light; apparatus for dividing the source into an object beam and a reference beam; apparatus, positioned along the path of the object beam for positioning an image; apparatus for supporting a recording medium in both the object beam path and the reference beam path; and apparatus positioned along the reference beam path for dividing the reference beam into a plurality of identical reference beams each having its own path. Each of the reference beam paths intersects the object beam path at the recording medium support. The object beam path and each of the reference beam paths, from the apparatus for dividing to the recording medium support, has the same length. Preferably, the apparatus for dividing includes a plurality of optical fibers, each of which addresses the recording medium support from a different angle. The output end of each fiber is equally spaced from the recording medium. The printer further includes a fused optical fiber and apparatus (e.g. a polarization maintaining splitter array) for dividing the fused optical fiber into the plurality of optical fibers. The printer also includes apparatus for supporting each of the output ends of the plurality of fibers for adjusting the angular orientation of each output end relative to the recording medium support, and for adjusting the distance between each output end and the recording medium support.

In one embodiment the printer includes a shutter positioned between the source and the apparatus for dividing, whereby when the shutter is opened, the recording medium is simultaneously exposed to both the object beam and the plurality of reference beams. In an alternate version, the printer includes a plurality of shutters, including a shutter positioned in the object beam path between the apparatus for dividing and the recording medium support, and a shutter for each of the plurality of reference beams. In this alternate embodiment, a shutter control mechanism is provided for sequentially opening each of the reference beam shutters with the simultaneous opening the object beam shutter each time one of the reference beam shutters is opened. Preferably, the printer includes a liquid crystal panel and a computer for supplying images in the liquid crystal panel. The computer changes the image in the liquid crystal panel between each sequential opening of the shutters.

For producing linear integral holograms, the printer includes apparatus positioned along the object beam path between the dividing apparatus and the recording medium support, for dividing the object beam into a plurality of object beams, each having its own path. Each of the object beam paths intersects the reference beam paths at the recording medium support. In this embodiment, each of the object beams and each of the reference beams also includes beam focusing in the form of cylindrical lenses. As with the reference beams, the apparatus for dividing the object beam includes a plurality of optical fibers.

The present inventions also relate to a method of forming a holographic image in a recording medium including the steps of: providing a recording medium; providing an image; exposing the image and the recording medium to an object beam; and, simultaneously with the object beam exposure, exposing the recording medium to plurality of reference beams. Alternately, the method of forming a holographic image in a recording medium with a printer having an object beam path and a plurality of reference beam paths, includes the steps of: positioning a recording medium in both the object beam and the referenced beam paths; positioning an image in said object beam path; exposing the image and the recording medium to an object beam; simultaneously with the object beam exposure, exposing the recording medium to a first reference beam via one of the reference beam paths; changing the image; exposing the changed image and the recording medium with the object beam; and simultaneously with the second exposure of the object beam, exposing the recording medium to a second reference beam via another of the reference beam paths. The process is continued for each reference beam.

### BRIEF DESCRIPTION OF THE DRAWINGS

FIG. 1 is a top plane schematic view of the first embodiment of the present invention, where the object beam and reference beams are superimposed at the front surface of the recording medium;

FIG. 2 is a partial side view of the composite printer of FIG. 1, taken along plane A-A;

FIG. 3 is the front view of the fiber optic holder of the present invention;

FIG. 4 is the side sectional view of the holder of FIG. 3, taken along line B-B;

FIG. 5 is the top plane view of the fiber optic holder of FIG. 3;

FIG. 6 is a partial top plain view of an alternate variation of the first embodiment, wherein the reference beams are projected onto the back surface of the recording medium;

FIG. 7 is a partial perspective view illustrating the use of an LCD and computer in conjunction with the printer of FIG. 1;

FIG. 8 is a perspective view of the holographic diffuser element of the present invention;

FIG. 9 is a partial perspective view of an additional embodiment of the present invention, where the reference beams are illuminated sequentially;

FIG. 10 is a partial plane view of multiple reference beams, in conjunction with cylindrical lenses, for use in producing holographic integrals;

FIG. 11 is a partial plane view of multiple object beams, in conjunction with cylindrical lenses, for use in producing holographic integrals; and

FIG. 12 is a top plane schematic of the embodiment for producing near real color composite holograms.

### DESCRIPTION OF THE PREFERRED EMBODIMENTS

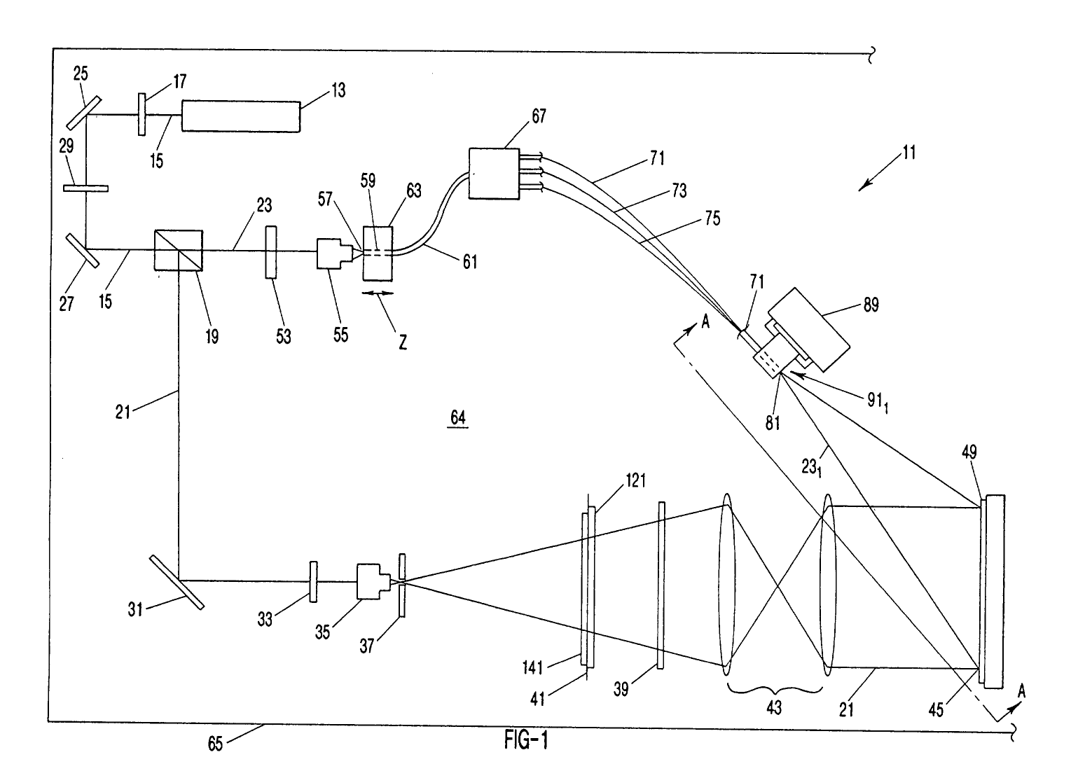

FIG. 1 illustrates the essential components of the first embodiment of the present invention. Printer 11 includes laser 13 (e.g., a 532 Argon), which produces a beam 15 of coherent polarized light, a solid state shutter 17, and a beam splitter 19. As those skilled in the art will appreciate, the specifics of the laser will depend on a number of factors, such as the size of the composite hologram, the wavelength, and the exposure parameters of the film used. As those skilled in the art will also appreciate, to eliminate vibrations caused by printer 11, it is necessary that shutter 17 be of a non-mechanical design, such as an acousto-optic device (such as manufactured by Isomet Corp., Springfield, Va.), or an LCD. In the case of acousto-optic devices, high frequency sound waves will deflect beam 15 away from beam splitter 19 and thus turn the beam “off.” Beam splitter 19 divides beam 15 into an object beam 21 and a reference beam 23. Between shutter 17 and beam splitter 19 are a pair of front surface mirrors 25 and 27, and a half wave plate 29. After beam splitter 19, object beam 21 is first redirected by front surface mirror 31 before it passes through a half wave plate 33 and then a microscope objective 35, which causes the beam to converge at spatial (pinhole) filter 37 which, in turn, filters beam 21 (e.g., removes noise, scatter and aberrations). As is also evident from FIG. 1, after passing through filter 37, beam 21 diverges and then passes through the plane 41 in which the image is positioned, projection lens system 43, and onto recording medium 45, supported by film holder 47. The top of recording medium 45 is indicated at 49. Lens system 43 focuses the image on recording medium 45 and controls the size of such image. In one embodiment, the image positioned in image plane 41 is a film transparency of any type of image. Alternate types of images and methods for positioning such images in plane 41 are set forth below.

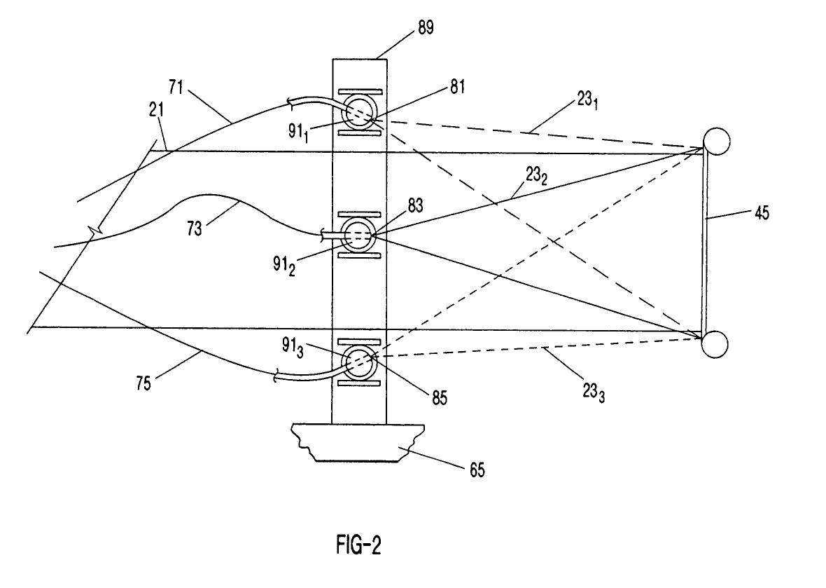

Again with reference to FIG. 1, reference beam 23 passes through a third half wave plate 53, and then a microscope objective 55, which focuses beam 23 down to a point at the face 57 of input end 59 of fused optical fiber 61. To insure proper optical alignment, input end 59 is held on an X-Y positioned 63, which is also movable relative to the surface 64 of printer table 65 in the Z direction (by any suitable positioning apparatus, not shown). In 1×3 polarization maintaining splitter array 67 (such as manufactured by Canadian Instrumentation & Research Ltd., Ontario, Canada) fused fiber 61 is divided into reference beam optical fibers 71, 73, 75. The type of fiber used can depend on such factors as the wavelength of the laser used. In the embodiment illustrated in FIGS. 1 and 2, each of fibers 71, 73 and 75 are Fibercore HB450 (532 nm) polarization maintaining fibers. The wavelength of the laser used will also affect the specifics of other optical components (e.g., beam splitter 19, lenses, and the half wave plates). For instance, with 532 nm fibers, the half wave plates will also be 532 nm. Fibers 71, 73 and 75 need to create identical reference beams, yet address the recording medium from different angles. Also, these optical reference path lengths, from beam splitter 19 to the plane of recording medium 45, must be the same as that of object beam 21. Splitter array 67 divides reference beam 23 into reference beams 23₁, 23₂ and 23₃, with equal intensities (+5% at 532 nm), lengths and beam diameters. As each fiber is a PM (i.e., polarization maintaining) fiber, the polarization of the divided reference beams 23₁, 23₂, 23₃ is maintained. At the output ends 81, 83 and 85, the reference beams diverge onto recording medium 45. In this embodiment each fiber is a single mode fiber that has a typical NA (numerical aperture) of 0.12. For smaller holograms, the output beam of each fiber could be optically coupled to a converging lens (not shown). For larger holograms, the output beam of each fiber would be optically coupled to a diverging lens (also not shown). Alternately, so long as the object beam path is equal in length to each of the reference beam paths, output ends 81, 83 and 85 could be moved closer to or pulled back from the plane of film 45. In all cases the diameter (at the plane of the recording medium) of the reference beam should match the diameter of the object beam for even illumination.

In recording holograms on recording medium 45 it is important that each of reference beams 23₁, 23₂, and 23₃ (23ₙ where there are more than 3 fibers) overlap object beam 21 (as discussed above) and strike recording medium 45 from equal distances, so that each will provide uniform properties of coherence, phase and frequency at recording medium 45. Thus, the axis of each of beams 23₁, 23₂, 23₃, . . . 23ₙ must intersect the axis of object beam 21 at the plane of recording medium 45. Also, the distance from each of output ends 81, 83 and 85 to the point where the respective axis of each reference beam 23₁, 23₂, and 23₃ intersects the plane of recording medium 45 must be the same. To achieve this, output ends 81, 83 and 85 are positioned in a plane perpendicular to top surface 64 of printer table 65 by support post 89 and holders 91₁, 91₂ and 91₃, as best illustrated in FIG. 2. With this arrangement, and because of the location of the top 49 of recording medium 45, the reference beams 23₁, 23₂, and 23₃ are positioned off axis to and above object beam 21.

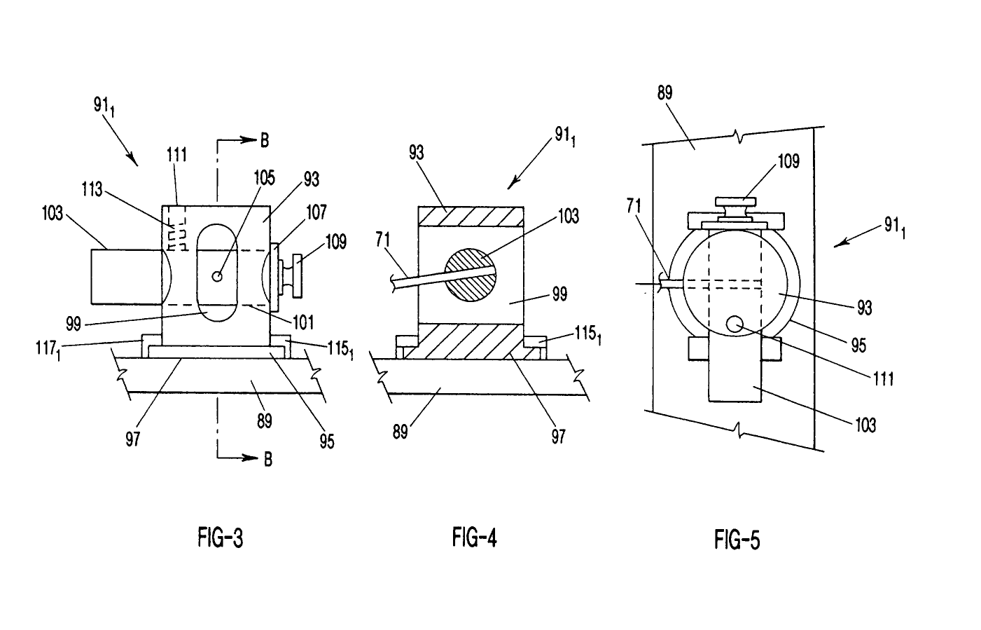

With reference to FIGS. 3, 4 and 5, each holder 91₁, 91₂ and 91₃ includes a cylindrical housing 93 having a cylindrical lip 95 and a flat button 97. Housing 93 includes an oblong through opening 99 and, at right angles thereto, a cylindrical opening 101. Received in opening 101 is fiber holding cylinder 103, having an opening 105 to receive, in this instance, fiber 71, a shoulder 107 and a knurled knob 109. Housing 93 also includes a tapped opening 111 in which is received set screw 113. Finally, lip 95 is received in a pair of spaced apart channels 115₁, 117₁which are incorporated in or secured to post 89 in any conventional manner. To assure fiber 71 is properly positioned, so that reference beam 23₁ overlaps object beam 21 in the same location at recording medium 45, holder 91₁ is first adjusted in the Z direction by moving it back or forth (as the case may be) in channels 115₁, 117₁ and then locking it in position by, for instance, a set screw (not shown). Further alignment of fiber end 81 so that the axis of beam 23₁, intersects the axis of object beam 21 in the plane of recording medium 45 is achieved by rotation and/or translation of holding cylinder 103 and then locking cylinder 103 in position with set screw 113. Due to the diameter of and tolerance on opening 105, fiber 71 does not move relative to cylinder 103 in the above described adjustment. With a looser tolerance, a lock down nylon set screw (or equivalent) (not shown) would be required. Finally, polarization alignment with object beam 21 can be achieved by rotating fiber 71 relative to opening 105. The foregoing alignment process is then repeated for fibers 73 and 75, so that all 3 reference beams overlap, are superimposed on, and have polarization alignment with object beam 21 at the same location on recording medium 45.

In operation, with a transparent image positioned in plane 41 and, for instance, a sheet of recording medium 45 in holder 47, as illustrated in FIG. 1, shutter 17 is electronically opened. Via beam splitter 19, beam 15 to be divided into object beam 21 and reference beam 23. Object beam 21 passes through the transparent image which, via projection lens system 43, is focused on the film. Simultaneously, reference beam 23 is divided into a plurality of beams 23₁, 23₂, and 23₃, which divided beams are also directed onto the plane of recording medium 45. As discussed above, each of beams, 23₁, 23₂, and 23₃ overlap object beam 21 to produced a simultaneous holographic image with only one opening and closing of the shutter 17. Because recording medium 45 is simultaneously exposed with a plurality of reference beams, the step, stop, wait, expose, and repeat process, with its inherent time delays is obviated. The requirement of prior art printers for a multiplicity of separate exposures (even for one object image) is avoided. Also, as those skilled in the art will appreciate, the single exposure makes optimum use of photopolymer film, as all areas to be exposed are exposed in a single exposure. This results in a single frame having a wide field of view.

As laser 13 has a fixed polarization, rotation of half wave plate 29 controls the polarization of beam 15. Beam splitter 19 also has a fixed polarization. Thus, rotation of half wave plate 29 varies the ratio of the intensity of the object beam 21 to that of reference beam 23. The polarization of object beam 21 and reference beam 23 can be further controlled by, respectively, half wave plates 33 and 53. Since LCD 121 (discussed below) also has a fixed polarization, by controlling the orientation of beam 21, via linear polarizer 39, the transmission of LCD 121 is optimized. With the use of polarizer 39, adjusting half wave plates 33 and 53 and rotation of the ends 81, 83 and 85, polarization of reference beams and object beam is achieved at the recording plane.

While three reference beams are illustrated, the inventions are not so limited. The greater the number of reference beams, the greater the dynamic range of the finished hologram (e.g., the wider the viewing angle and the greater the depth perception). More reference beams can be obtained by, for instance, fusing additional fibers into fused fiber 61. An alternate approach would be to couple the output of each of fibers 71, 73 and 75 with a 1×3 polarization maintaining splitter array (such as array 67) to obtain 9 reference beam fibers. This arrangement could be repeated to obtain, in successive steps, 27 reference beam fibers, 81 reference beam fibers, etc. As those skilled in the art would appreciate, the coupling of each fiber end with a splitter array will require the use of a microscope objective.

The above described process produces top lit transmission holograms. By repositioning the reference beams one can reconstruct the image from any angle. Also, the distance between ends 81, 83 and 85 and the point of intersection with the axis of object beam 21 can be varied. The shorter this distance, the closer the illumination source, up to and including edge lit holograms. Again, for even illumination in the plane of the recording medium the diameter of the reference beams must be the same diameter as the object beam.

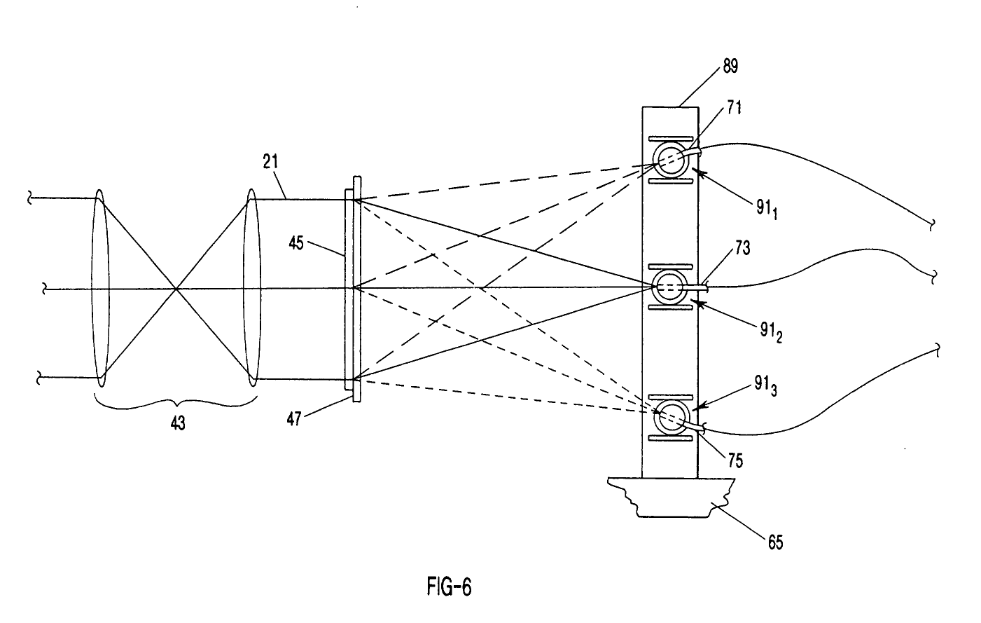

In order to produce a reflection hologram, the reference beams must come in from behind the recording medium. This arrangement is illustrated in FIG. 6, wherein fiber holders 91₁, 91₂, and 91₃, are located behind film holder 47 and recording medium 45. The position and function of the optical components positioned along the axis of object beam 21 remain unchanged. Except for the position of holders 91₁, 91₂, and 91₃, the position and location of the components along the axis of reference beams 23, 23₁, 23₂, and 23₃ also remains the same. Again, as those skilled in the art will appreciate, the optical path length from beam splitter 19 to the recording medium must be the same for both the object beam and the reference beams. The adjustment of position and polarization of the reference beams on recording medium 45 is also the same as before. As with the first embodiment, there is only a single opening of shutter 17 and a single simultaneous exposure of the recording medium by the object beam and the plurality of reference beams. For the reasons discussed above, the number of reference beams is not limited to the three illustrated.

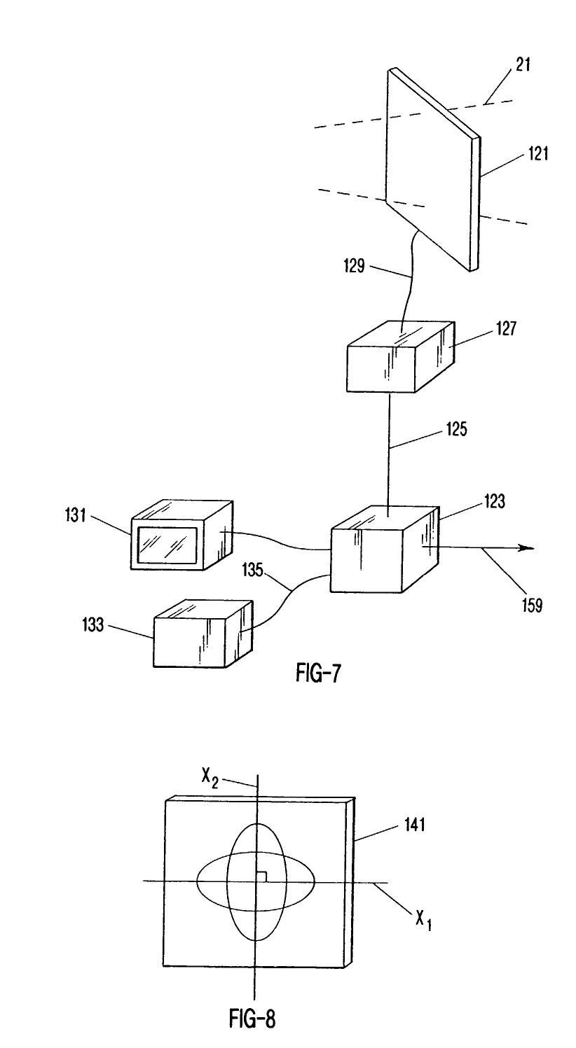

While a single transparency can be located in plane 41, other types of imagery can be used. With reference to FIGS. 1 and 7, LCD 121 is positioned in plane 41. The image in LCD 121 is transmitted from computer 123, via cable 125, LCD controller 127 and cable 129. The computer 123 includes such components as RAM, hard drive, a data converter and a CCD camera port. The image, viewable on monitor 131, can be a simple one, such as of an individual or object taken by CCD camera 133 and connected to computer 123 via cable 135. However, the image may also be a more complex single image, such as a human image electronically combined with, for instance, a logo, identification number, and/or bar code). Thus, the type of image transmitted to LCD 121 from computer 123 can be manipulated, via suitable conventional software, by an operator and viewed on monitor 131 prior to transmission to LCD 121 . Additionally, images can be sent from a remote computer by uploading to computer 123's e-mail account, or through a website, either of which would store information until later downloaded and displayed on LCD 121 for hologram construction. In addition to CCD camera 133, images can also be transferred to computer 123 from, for instance, scanning still photographs, digital video, CD-ROM, DVD imagery, or satellite uplink. In addition to controlling the image displayed on LCD 121, computer 123 controls shutter 17, and the repositioning of new film for printing a new hologram. Computer memory permits fast and easy access to all stored imagery.

With reference to FIGS. 1 and 8, printer 11 can also include a holographic optical diffuser element 141. Element 141 is the composite of two elliptical holographic diffusers. While, in general, holographic diffusers are not new, element 141 is unique in that it is a composite of two elliptical diffusers positioned so that the principal axis of one is at right angles to the principal axis of the other. By placing element 141 in object beam path 21, in front of and in contact with LCD 121, the angular spread of the field of view of the holographic image recorded on recording medium 45 is widened on both the X and Y directions. Secondly, the vertical color gradient inherent in transmission rainbow holograms is lessened.

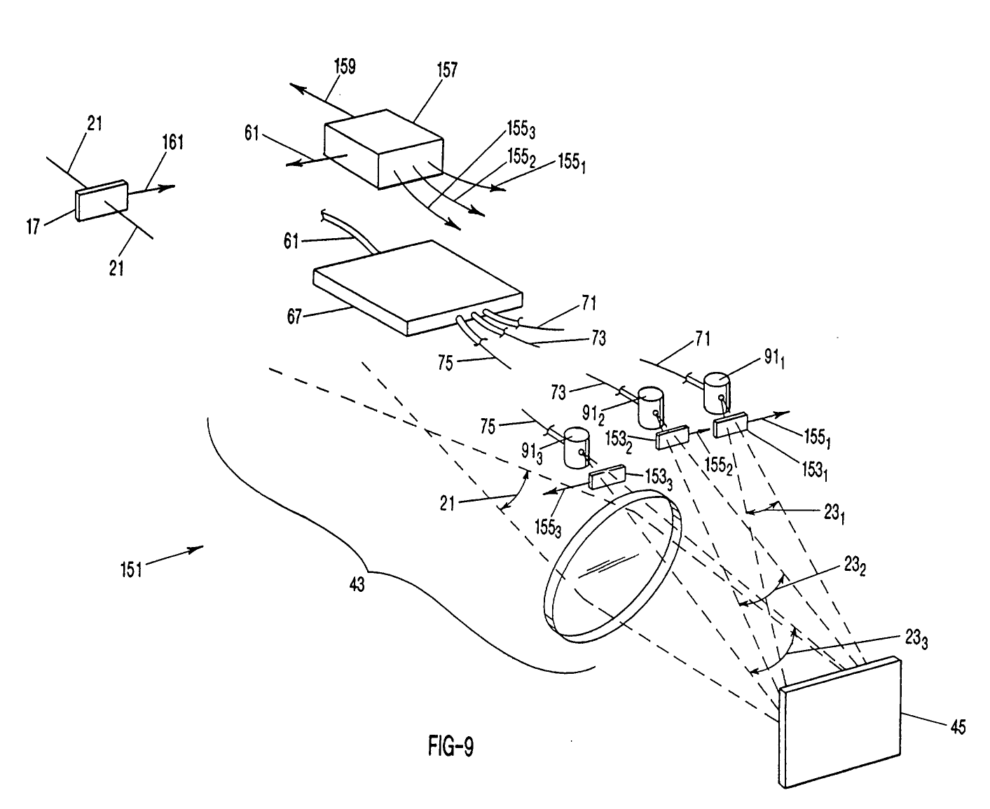

FIG. 9 is a partial perspective schematic of the embodiment of the present invention where the reference beams are used sequentially instead of simultaneously. Except as described herein, printer 151 has the same optical components and same arrangement of components as printer 11. Thus, printer 151 includes laser 13, mirrors 25 and 27, and beam splitter 19. Elements 31, 33, 35, 37 and 43 are positioned along beam path 21 as before. LCD 121, holographic optical diffuser 141, and polarizer 39 are also included. The only difference along beam path 21 is the relocation of solid state shutter 17 to a position after beam splitter 19. Reference beam path 23 also includes the same components including: half wave plate 53; microscope objection 55; face 57 of end 59 of fused optical fiber 61; X-Y positioned 63; splitter array 67; optical fibers 71, 73 and 75; and fiber holders 91, 91₂, and 91₃. The positioning of output ends 81, 83 and 85 (e.g., so that each of reference beams 23₁, 23₂ and 23₃ is equidistant from the film plane, and offaxis to and above object beam 21) is also the same as in the embodiment of FIG. 1. The importance of beam overlap and polarization also remains the same. However, for sequential use of reference beams 23₁, 23₂, and 23₃, solid state shutters (e.g. acousto-optic devices) 153₁, 153₂ and 153₃ are interposed in front of and close to output ends 81, 83 and 85, as illustrated in FIG. 9. All the shutters are electronically coupled (via connectors 155₁, 155₂ and 153₃) to and controlled by controller 157 which, in turn, is connected (via connector 159) to and controlled by computer 123. Shutter 17 is, via connector 161, connected to an controlled by computer 123. As with the previous embodiment, the step, stop wait and repeat process is obviated. (The entire recording procedure, including the sequential printing of images from LCD 121 and the opening and closing of the solid state shutters, is all accomplished without mechanical motion.)

In operation, with a sheet of recording medium 45 positioned in holder 47 and an image conveyed in LCD 121 (by computer 123) shutters 17 and 153₁ are simultaneously electronically opened (for a predetermined interval of time) to permit object beam 21 and reference beam 23₁ to illuminate a first image in recording medium 45. Without moving the recording medium, the image in LCD 121 is then electronically changed and shutters 17 and 153₂ simultaneously opened (for the same predetermined interval of time) for the predetermined amount of time to illuminate a second image in recoding medium 45. Again, the image in LCD 121 is electronically changed and shutters 17 and 153₃ simultaneously opened (again for the same predetermined interval of time) to illuminate a third image in recording image an recording medium 45. As the changing of the image in LCD 121 and the sequential opening and closing of shutters is all electronically controlled, a 3 exposure composite can be formed in recording medium 45 in near real time. The fact that all the shutters are solid state, that the images are changed electronically in LCD 121, and the film dos not move (until the hologram is finished), all facilitate the near real time exposure process.

The composite hologram produced by printer 151 can be, for instance, three different views of the same individual or object (with or without an identification number, logo or bar code). However, the superimposed sequence of images may also be more complex, such as a sequential movie series. Also, conventional medical images of the human body (slice by slice) can be transferred from the computer and a series of superimposed images can be printed into a multi-imaged hologram for proportional depth analysis of medical disorders. The type of image transmitted to LCD 121 from computer 123 can be manipulated, via suitable conventional software, by an operator and viewed on monitor 131 prior to transmission to LCD 121. Additionally, images can be sent from a remote computer by uploading to computer 123's e-mail account, or through a website, either of which would store information until later downloaded and displayed on LCD 121 for hologram construction. In addition to CCD camera 133, images can also be transferred to computer 123 from, for instance, x-rays scanning still photographs, digital video, CD-ROM, DVD imagery, or satellite uplink. In addition to controlling the image displayed on LCD 121, computer 123 controls shutters 17 and 153₁-153ₙ, and the repositioning of new film for printing a new hologram. Computer memory permits fast and easy access to all stored imagery.

As those skilled in the art will appreciate, with additional reference beams, each with its own solid state shutter, and additional images electronically and sequentially positioned in LCD 121, near real time (e.g., milliseconds) a composite hologram with more information can be recorded. (In the case of composite medical images, more images would result in more information being recorded for dimensional analysis.) Since the sequential, multiple images are recorded in near real time, a considerable number of holograms can be recorded on a single frame of polymer film. With no settling time between exposures (as required by prior art printers), the monomer(s) in the film do not have time to polymerize until after the exposure sequence has been completed. As with the previous embodiment, the step, stop, wait and repeat process is obviated. The changing of images in LCD 121 and the opening of the solid state shutters is all accomplished without mechanical motion.

Conventional linear reflection and transmission composite integral holography can also benefit from the use of multiple fibers. (In linear integral holography both the object beam and reference beam are brought to a near focused slit at the recording medium. The recording medium is then moved a predetermined incremental amount, the system is allowed to settle, and the process repeated.) Thus, the use of a plurality of reference beams sequentially energized can also be used in the production of integral holograms of the type disclosed in U.S. Pat. No. 5,223,955 (the disclosure of which is incorporated by reference). By the use of multiple reference beams, in conjunction with multiple object beams, both the movement of the film between successive exposures and the need for settling time is avoided.

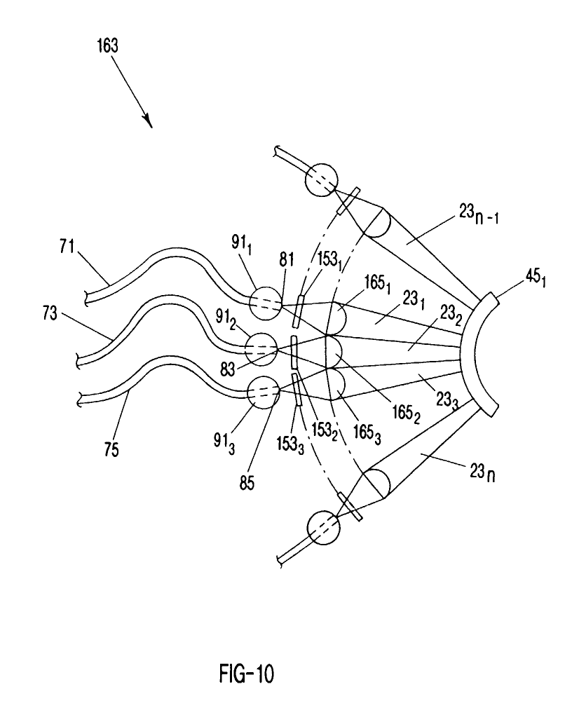

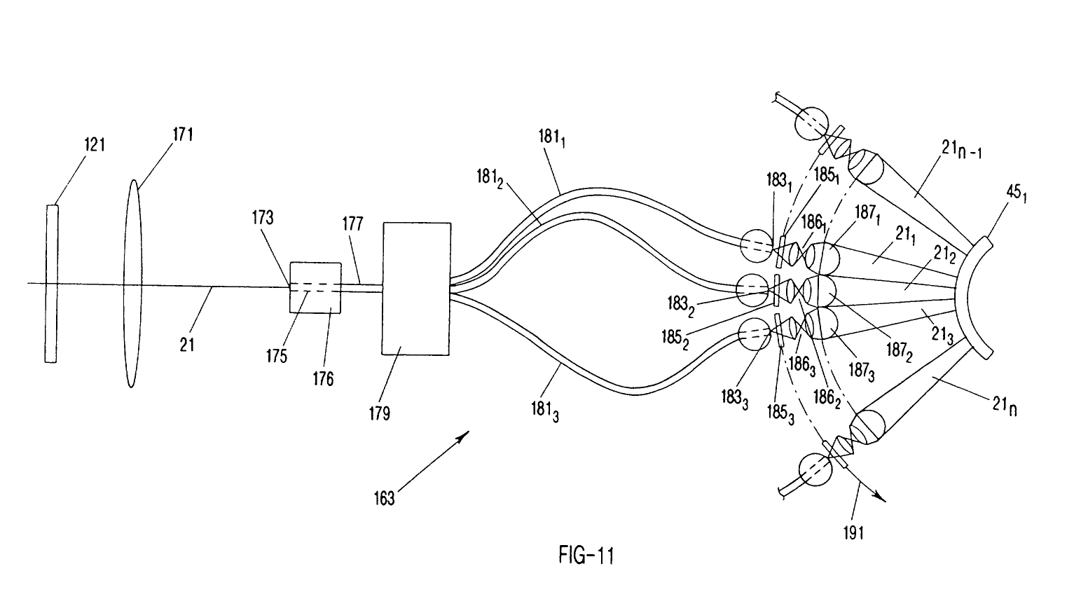

A solid state integral holographic printer 163 is partially illustrated in FIGS. 10 and 11. Except as indicated in the following paragraphs, this printer has the same components and component relationships as set forth with the previously described printers. Thus, for instance, printer 163 includes source 13, mirrors 25 and 27, and beam splitter 19. Along reference beam 23 there is: a half wave plate 53; microscope objective 55; X-Y positioned 63; polarization maintaining splitter array 67; optical fibers 71, 73 and 75; holders 91₁, 91₂, and 91₃; and shutters 153₁, 153₂, and 153₃. Along object beam 21 there is: half wave plate 33₈, microscope objective 35, filter 37, optical diffuser element 141, LCD 121, and linear polarizer 39. With reference to FIG. 10, in front of each of ends 81, 83 and 85 (and associated shutters 153₁, 153₂ and 153₃) cylindrical lens 165₁, 165₂ and 165₃ are positioned to focus each reference beam as a slit in the plane of recording medium 45₁ (which is curved in this case). Multiple object beams would also be necessary. With reference to FIG. 11, object beam 21 is brought to a focus by lens series 171 at the face 173 input of end 175 of fused optical fiber 177. Again, the type of fiber used will depend on such factors as the wavelength of the laser used. Like fused optical fiber 61, to insure proper optical alignment, end 175 is held in an X-Y positioned 176, which is also movable relative to the printer table in the Z direction (by any suitable positioning apparatus, not shown). In polarization maintaining splitter array 179 (again, such as manufactured by Canadian Instrumentation & Research Ltd.) fused fiber 177 is divided into, for instance, object beam optical fibers 181₁, 181₂ and 181₃. Fibers 181₁, 181₂ and 181₃ need to be of equal length with each other. Also, these object beam path lengths, from beam splitter 19 to the plane of recording medium 45₁, must be the same as that of the reference beam paths. Splitter array 179 divides object beam 21 into object beams 21₁, 21₂ and 21₃, with equal intensities from LCD 121. As each fiber is a PM (i.e., polarization maintaining) fiber, the polarization of the divided object beams 21₁, 21₂ and 21₃ is maintained. At the output ends 183₁, 183₂ and 183₃, which are held by fiber holders 184₁, 184₂, and 184₃, the object beams diverge toward recording medium 45₁. As is evident from FIG. 11, interposed between output ends 183₁, 183₂ and 183₃ and recording medium 45₁ are shutters 185₁, 185₂ and 185₃, cylindrical lenses 187₁, 187₂ and 187₃ and lenses 186₁, 186₂ and 186₃ which focus the images on the face of the cylindrical lenses. Like the cylindrical lenses interposed in the reference beam paths, lenses 187₁, 187₂ and 187₃ focus the respective object beams down to a near slit. Shutters 185₁, 185₂ and 185₃ are connected via cables (one of which is shown at 191) to controller 157 which, in turn, is connected to computer 23. The three reference beams and three object beams illustrated in FIGS. 10 and 11 are merely illustrative. To increase the dynamic range of the hologram to be produced, a large number of reference and object beams (e.g., 50) would be required. Representative additional reference beams (23ₙ₋₁ and 23ₙ) and object beams (21ₙ₋₁ and 21ₙ) and their associated fibers, holders, shutters and cylindrical lense is indicated in FIGS. 10 and 11.

The procedure for producing a reflection integral hologram is much the same as set forth in U.S. Pat. No. 5,223,955. Thus, each pair of object and reference beams (e.g., 21₁, and 23₁) have to be aligned in overlapping relationship in the plane of recording . To expose the first slit on recording , an image is electronically positioned in LCD 121 and, for instance, shutters 153₁ and 185₁ simultaneously opened. The next image is then electronically positioned in LCD 121 and the process repeated with the next paired shutters (e.g., 153₂ and 185₂) until the integral is finished. The sequencing of the images in LCD 121 and the opening of the shutters is controlled via controller 157 and computer 23. While only three object beams and three reference beams are illustrated, many more beams can be utilized (in association with a like number of additional images). With the repositioning of the reference beams from in front of the recording medium to behind it, and keeping object beam and reference beam paths (from the beam splitter to the plane of the recording medium) of equal length, the foregoing can be used to produce transmission integrals.

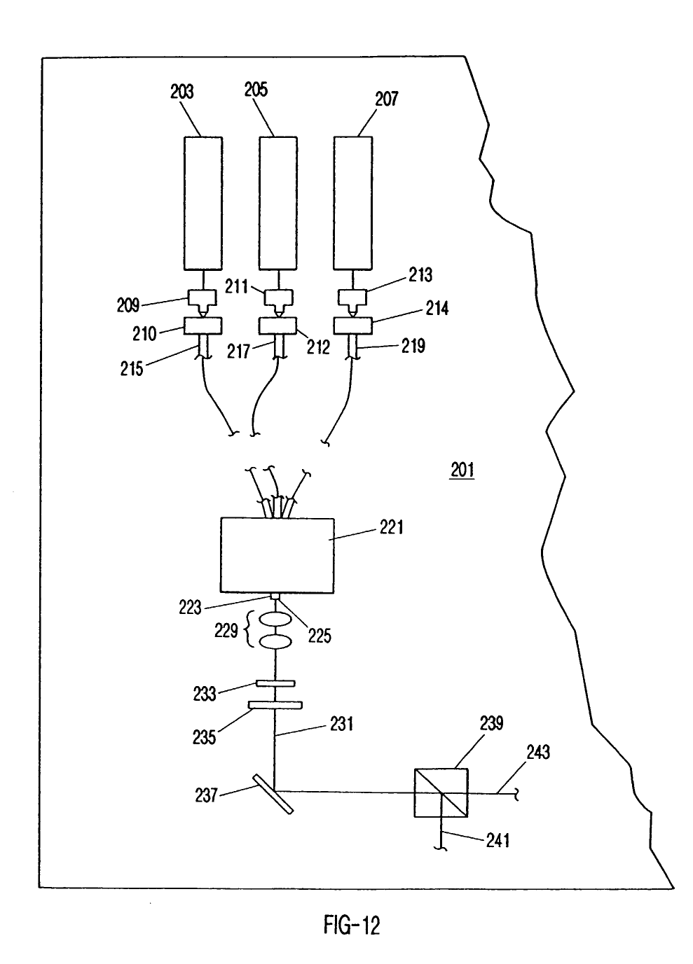

The use of fiber optics can also be used to generate near real color composite and integral holograms by simultaneously exposing the recording medium with laser light of appropriately selected, different frequencies. With reference to FIG. 12, printer 201 includes lasers 203 (for instance, a krypton 633 nm laser), 205 (for instance, an argon 532 nm laser) and 207 (for instance, a helium cadmium 442 nm laser). The beams from each of those three lasers are transmitted via microscope objectives 209, 211 and 213 and fiber optic cables 215, 217 and 219 to splitter array 221, where the three fibers are fused into output fiber 223. Objectives 209, 211 and 213 are necessary to focus the beams from the respective lasers onto the ends of fibers 215, 217 and 219, each of which is held by, respectfully, an X-Y positioners 210, 212 and 214. The polarities of the three beams are matched by twisting the ends of fibers 215, 217 and 219 relative to their respective microscope objectives. The beam 227 from output end 225 of fiber 223 is controlled by lens system 229 after which the beam passes through shutter 233, half wave plate 235, and off mirror 237 to beam splitter 239. In turn, beam splitter 239 divides beam 227 into object beam 241 and reference beam 243. Object beam is then directed, via the same type of optics identified in reference to FIG. 1 (not shown in FIG. 12), through an image (not shown) and onto the recording medium (also not shown). Similarly, reference beam 243 passes through the same type of optical system as discussed in reference to FIG. 1, including being focused down to a point source at the face (not shown) of a fused optical fiber (also not shown). This fused fiber is then, like the first embodiment, divided by (for instance) a 1×3 polarization maintaining splitter (not shown) into three reference beam optical fibers (also not shown). The balance of the reference beam system is the same as set forth in regard to the embodiment of FIG. 1. The length optical path of the object beam path (from the beam splitter to the recording medium) is the same as that for each of the reference beams. Also, the length of beam paths from each of lasers 203, 205 and 207 to output end 225 of fiber 223 is the same. For simultaneous exposure of the recording medium the operation of printer 201 is the same as the first embodiment. For near real time multiple exposures, the shutters and shutter controls of printer 151 are required. In either application, the recording medium used must be sensitive to the wavelengths of light used. HRF-800X or HEF850X full color polymer film manufactured by Du Pont has been used with excellent results. Care should be taken to adjust the output of each laser for the aggregate sensitivity of each of wavelength of the film to insure uniform color exposures.

Whereas the drawings and accompanying description have shown and described the preferred embodiment of the present invention, it should be apparent to those skilled in the art that other various changes may be made in the form of the invention without affecting the scope thereof. For instance, multiple reference beams can be used in the formation of conical holographic stereograms.

I claim:

1. A holographic printer comprising:
(a) a source of coherent light;
(b) means for dividing said source into an object beam and a reference beam, said object beam having a beam path, said reference beam having at least one beam path;
(c) means, positioned along said object beam path, for positioning an image in said object beam path;
(d) means for supporting a recording medium in both said object beam path and said reference beam path; and
(e) means, positioned along said reference beam path between said dividing means and said recording medium support, for dividing said reference beam into a plurality of identical reference beams, each having its own path, each of said reference beam paths intersecting said object beam path at said recording medium support.

2. The printer of claim 1, wherein said means for dividing includes a plurality of optical fibers.

3. The printer of claim 2, wherein said object beam path, from said means for dividing to said recording medium support, has a given length, and wherein each of said reference beam paths, from said means for dividing to said recording medium support has said given length.

4. The printer of claim 3, wherein each of said plurality of fibers addresses said recording medium support from different angles.

5. The printer of claim 2, further including a fused optical fiber and means for dividing said fused optical fiber into said plurality of optical fibers.

6. The printer of claim 5, wherein said means for dividing is a polarization maintaining splitter array.

7. The printer of claim 2, wherein each of said plurality of fibers has an output end, each of said output ends being equally spaced from said recording medium support.

8. The printer of claim 7, further including means for supporting each of said output ends of said plurality of fibers.

9. The printer of claim 8, wherein each of said fiber support means includes means for holding said output end, means for adjusting the angular orientation of said output end relative to said recording medium support, and means for adjusting the distance between said output end and said recording medium support.

10. The printer of claim 1, further including shutter means.

11. The printer of claim 10, wherein said shutter means is non-mechanical.

12. The printer of claim 10, wherein said shutter means is a solid state means.

13. The printer of claim 10, wherein said shutter means is positioned between said source and said means for dividing, whereby when said shutter is opened, said recording medium support is simultaneously exposed to said object beam and said plurality of reference beams.

14. The printer of claim 10, wherein in said shutter means includes a plurality of shutter means, said plurality of shutter means including a shutter means positioned in said object beam path between said means for dividing and said recording medium support, said plurality of shutter means also including a shutter means for each of said plurality of reference beams.

15. The printer of claim 14, further including shutter control means for controlling each of said plurality of shutter means, said shutter control means including means for sequentially opening each of said reference beam shutter means, said means for opening also including means for opening said object beam shutter each time one of said reference beam shutter means is opened.

16. The printer of claim 15, wherein said plurality of shutter means are non-mechanical.

17. The printer of claim 1, wherein said means for positioning an image includes means for holding a transparency.

18. The printer of claim 1, wherein said means for positioning an image is a liquid crystal panel.

19. The printer of claim 18, further including means for supplying images to said liquid crystal panel.

20. The printer of claim 19, wherein said means for supplying images includes computer means.

21. The printer of claim 20, further including a plurality of shutters, said plurality of shutters including a shutter positioned in said object beam path between said means for dividing and said recording medium support, said plurality of shutters also including a shutter for each of said plurality of reference beams.

22. The printer of claim 21, further including shutter control means for controlling each of said plurality of shutters, said shutter control means including means for sequentially opening each of said reference beam shutters, said means for opening also including means for opening said object beam shutter each time one of said reference beam shutters is opened, said computer changing said image in said liquid panel between each sequential opening of said shutters.

23. The printer of claim 1, further including a holographic diffuser, said diffuser positioned in said object beam path adjacent said means for positioning an image.

24. The printer of claim 23, wherein said holographic diffuser element includes two elliptical holographic diffusers positioned relative to each other such that the principal axis of one is perpendicular to the principal axis of the other.

25. The printer of claim 1, wherein each of said plurality of reference beams includes means for beam manipulation.

26. The printer of claim 25, wherein each of said means for beam focusing is a cylindrical lens.

27. The printer of claim 26, further including means, positioned along said object beam path between said dividing means and said recording medium support, for dividing said object beam into a plurality of object beams, each having its own path, each of said object beam paths intersecting said reference beam paths at said recording medium support, each of said object beams further including beam focusing means in the form of cylindrical lenses.

28. The printer of claim 27, wherein said means for dividing includes a plurality of optical fibers.

29. The printer of claim 28, wherein each of said plurality of fibers has the same length.

30. The printer of claim 29, wherein said means for dividing is a polarization maintaining splitter array.

31. A color holographic printer comprising:
(a) a plurality of sources of coherent light, each of said sources having a different wavelength;
(b) means for combining said different wavelengths into a single beam;
(c) means for dividing said single beam into an object beam and a reference beam, said object beam having a beam path, said reference beam having at least one beam path;
(d) means, positioned along said object beam path, for positioning an image in said object beam path; and
(e) means for supporting a recording medium in both said object beam path and said reference beam path.

32. The printer of claim 31, wherein said means for combining also includes a plurality of optical fibers, one for each source.

33. The printer of claim 32, wherein said means for combining also includes means for fusing said optical fibers.

34. The printer of claim 31, further including means positioned along said reference beam path between said dividing means and said recording medium support, for dividing said reference beam into a plurality of identical reference beams, each having its own path, each of said reference beam paths intersecting said object beam path at said recording medium support.

35. A holographic diffuser element including first and second elliptical holographic diffusers positioned relative to each other such that the principal axis of one of said diffusers is perpendicular to the principal axis of the other of said diffusers.

36. A method of forming a holographic image in a recording medium, said method including the steps of:
(a) providing a recording medium;
(b) providing an image;
(c) exposing said image and said recording medium to an object beam; and
(d) simultaneously with said object beam exposure, exposing said recording medium to plurality of reference beams.

37. A method of forming a holographic image in a recording medium with a printer having an object beam path and a plurality of reference beam paths. said method including the steps of:
(a) positioning a recording medium in both said object beam and said referenced beam paths;
(b) positioning an image in said object beam path;
(c) exposing said image and said recording medium to an object beam;
(d) simultaneously with said object beam exposure, exposing said recording medium to a first reference beam via one of said reference beam paths;
(e) changing said image;
(f) exposing said changed image and said recording medium with said object beam; and
(g) simultaneously with said second exposure of said object beam, exposing said recording medium to a second reference beam via another of said reference beam paths.

38. The method as set forth in claim 37, wherein after each exposure of said recording medium by said object beam, said image is changed, and wherein with each exposure by said object beam, said recording is simultaneously exposed to one of a sequence of different reference beams.
